(19) United States
(12) Patent Application Publication
(10) Pub. No.: US 2008/0083060 A1
(43) Pub. Date: Apr. 10, 2008

(54) BEDPAN AND METHOD FOR REMOVAL OF THE CONTENTS THEREOF

(75) Inventors: Jeffrey Beers, Akron, OH (US); Dale W. Vernon, Mentor, OH (US); Detlev F. Smith, Fairlawn, OH (US)

Correspondence Address: RENNER OTTO BOISSELLE & SKLAR, LLP, 1621 EUCLID AVENUE, NINETEENTH FLOOR, CLEVELAND, OH, 44115, US

(73) Assignee: SUDI MEDICAL, LLC, Concord, OH (US)

(21) Appl. No.: 11/956,482

(22) Filed: Dec. 14, 2007

Related U.S. Application Data
(63) Continuation-in-part of application No. PCT/US2006/060232, filed on Jun. 14, 2006.
(60) Provisional application No. 60/690,289, filed on Jun. 14, 2005.
(60) Provisional application No. 60/762,767, filed on Jan. 27, 2006.

(51) Int. Cl. A61G 9/00

(52) U.S. Cl. 4/455

(57) ABSTRACT

A bedpan having a port for removing human waste contained in the device and a method for removing human waste, especially fluidic human waste from the bedpan in order to eliminate or substantially reduce exposure to human waste. The bedpan generally includes a vessel capable of holding waste (e.g., urine, feces, diarrhea, etc.) and a port (e.g., nozzle, barb, extender, recess, void, etc.) that may be configured to allow the waste to be removed from the confines of the vessel and a filter/separator for separating and/or preventing solid human waste from entering the port. Optionally, a storage element is coupled to the bedpan to evacuate the fluidic human waster through the port. A gravity-type, suction-type or vacuum-type device (e.g., vacuum canister, evacuation chamber, etc.) may be used to enhance the removal of human waste from the confines of the bedpan.

### RELATED APPLICATION DATA

This application is a continuation-in-part of International Application No. PCT/US2006/023202, filed Jun. 14, 2006, which claims the benefit of U.S. Provisional Application No. 60/690,289, filed Jun. 14, 2005, and U.S. Provisional Application No. 60/762,767, filed Jan. 27, 2006, all of which are incorporated herein by reference.

### TECHNICAL FIELD OF THE INVENTION

The present invention relates generally to human waste collection devices and a method for removing human waste contained therein and, more particularly, to components (e.g., bedpans and storage elements) capable of holding human waste, wherein the bedpan includes a port configured to allow at least a portion of the human waste contained and/or deposited in the bedpan to egress or pass through the port, thereby limiting the risk of infection and disease exposure caused from human waste escaping the confines of the bedpan during use and/or transport.

### DESCRIPTION OF THE RELATED ART

Bedpans are commonly used for removing human waste in hospitals and nursing homes for patients that are temporarily or permanently bed-ridden (e.g., patient on an operating table, patient recovering from a total hip replacement surgery, patient suffering from a stroke or heart attack, catheterized recovery, etc.) or patients that are not able to easily ambulate. Typically, a bedpan is conveniently located next to the bed of such a patient, for example, near the patient's hospital bed, nursing home bed and/or procedure room. When the patient desires to urinate or otherwise relieve him or herself, a healthcare provider and/or caregiver positions the bedpan beneath the patient for receiving and accumulating the bodily waste expelled by the patient.

When the patient has completed expelling the bodily waste, the waste collection device is then typically carried by a healthcare provider and/or caregiver (e.g., nurse, doctor, aide, family member, etc.) to a restroom or similar facility for discarding of the bodily waste and rinsing or cleaning of the bedpan. Removing the bedpan with fluidic human waste (e.g., urine, feces, diarrhea, vomit, etc.) contained therein is often difficult and exposes the healthcare provider, the caregiver, the patient and other patients to a variety a harmful conditions including, for example, possible infections, exposure to diseases (e.g., Clostridium difficile (C-diff), Vancomycin-resistant Enterococci (VRE), Methicillin-Resistant Staphylococcus aureus (MRSA), Extended-Spectrum Beta-Lactamases (ESBL), Escherichia coli (E. Coli), Cytomegalovirus (CMV), Enterococcus, etc.), exposure to skin and eye irritants, wound and skin breakdown, skin care ailments, all of which may be caused by human waste, particularly fluidic human waste escaping the confines of the bedpan.

### SUMMARY OF THE INVENTION

A need exists for a bedpan and/or a storage element and a method for removing human waste in hospitals, procedure rooms (e.g., operating rooms), doctor's offices and/or nursing homes, which substantially limits exposure to infections and diseases caused from human waste escaping the confines of the bedpan during use, removal, transport and/or cleaning.

The present invention provides a bedpan having a port for removing human waste contained in the bedpan and a method for removing human waste, especially fluidic human waste from the bedpan in order to eliminate or substantially reduces exposure to human waste. The bedpan optionally includes a filter (also referred to as a separator) for preventing human waste of a predetermined size from entering the port from a plurality of directions and/or separating fluidic human waste from solid human waste during evacuation of the fluidic human waste from the bedpan.

A bedpan including: a portable vessel including at least one sidewall member and a bottom member, wherein the at least one sidewall member and the bottom member (16) are configured to define a cavity within the vessel capable of holding human waste, wherein the vessel is substantially rigid and adapted to be placed under an associated person; a port in fluid communication with the vessel, wherein at least a portion of the human waste deposited in the cavity is capable of egress through the port; and a filter for preventing human waste of a predetermined size from entering the port, wherein the filter allows for entry of human waste into the port from a plurality of directions.

A fluid collection management system including: a bedpan, as described above, and a storage element coupled to the bedpan through a conduit, and the storage element coupled to an associated suction device for imparting a suction force to the port for removing at least a portion of the associated human contained in the bedpan, thereby substantially reducing exposure of human waste to an associated health care providers and/or an associated patient.

A kit including a bedpan as described above; and a storage element packaged with the bedpan, wherein the storage element is capable of storing human waste.

A bedpan including: a base member including a substantially hollow and portable vessel adapted to hold human waste, wherein the vessel is substantially rigid and is configured to be placed under an associated person and a port formed in the vessel, wherein at least a portion of human waste contained in the vessel is capable of passing through the port and a seat member adapted to be secured to the base member, wherein the seat member includes a filter for preventing human waste of a predetermined size from entering the port.

A method of manufacturing a bedpan, the method including: forming a base member, wherein the base member includes a substantially hollow and portable vessel adapted to hold human waste, wherein the vessel is substantially rigid and is configured to be placed under an associated person and a port formed in the vessel, wherein at least a portion of human waste contained in the vessel is capable of passing through the port and forming a seat member adapted to be secured to the base member, wherein the seat member includes a filter for preventing human waste of a predetermined size from entering the port.

According to an aspect of the invention, a bedpan is provided that comprises: a portable vessel including at least one sidewall member and a bottom member, wherein the at least one sidewall member and the bottom member are configured to define a cavity within the vessel capable of holding human waste, wherein the vessel is substantially rigid and adapted to be placed under an associated person; and a port in fluid communication with the vessel, wherein at least a portion of the human waste deposited in the cavity is capable of egress through the port.

According to another aspect, the port is recessed within a sidewall member of the vessel and at least partially enters the cavity.

According to another aspect, the port extends outward from at least a portion of the bottom member of the vessel.

According to another aspect, the port extends outward from a sidewall member of the vessel.

According to another aspect, the port is coupled to a storage element through a conduit.

According to another aspect, the port is releasably coupled to the conduit.

According to another aspect, the conduit is a flexible tubing.

According to another aspect, the flexible tubing has a 5 millimeter diameter.

According to another aspect at least one end of the flexible tubing is secured to the port through a press-fit connector.

According to another aspect, the bedpan further includes a suction-type device coupled to the storage element for imparting a suction force to the storage element to remove at least a portion of the associated human waste from the vessel.

According to another aspect, the storage element is a vacuum canister.

According to another aspect, the bedpan further includes a filter that prevents associated human waste of a predetermined size from entering the port.

According to still another aspect, a bedpan is provided. The bedpan comprises: a substantially hollow and portable vessel capable of holding human waste, wherein the vessel is substantially rigid and is configured to be placed under an associated person; and a port formed in the vessel, wherein at least a portion of human waste contained in the vessel is capable of passing through the port.

According to another aspect, the port extends outward from at least a portion of a bottom member of the vessel.

According to another aspect, the port extends outward from at least a portion of a sidewall member of the vessel.

According to another aspect, the port is configured to be secured to a storage element through a conduit.

According to another aspect, the conduit is a flexible tubing.

According to another aspect, at least one end of the flexible tubing is secured to the port through a connector.

According to another aspect, the bedpan further includes a suction-type device coupled to the storage element for imparting a suction force to the storage element to remove at least a portion of the associated human waste contained in the vessel.

According to another aspect, the storage element is a vacuum canister.

According to another aspect, the bedpan further includes a filter that prevents the associated human waste from blocking the egress of at least a portion of the human waste through the port.

According to still another aspect, a method for emptying a bedpan is provided. The method includes providing a bedpan including a port extending from an outer surface of the bedpan and a cavity for storing human waste, wherein the port permits human waste contained in the cavity to be removed through the port; providing a flexible tubing having a first end and a second end, the first end for coupling the flexible tubing to a storage device and a second end for coupling the flexible tubing the port; placing the bedpan in a position to create a flow of human waste toward the port to eliminate at least a portion of the associated human waste contained in the cavity; and activating a suction device coupled to the storage device to remove at least a portion of the human waste contained within the bedpan through the port.

According to another aspect, the method further includes storing at least a portion of the associated human waste removed through the port in the storage device.

According to still another aspect, a method of retrofitting a conventional bedpan is provided. The method includes: providing a bedpan having a cavity for holding human waste; forming a hole into the cavity of the bedpan; securing a port to the bedpan, wherein the port allows at least a portion of the human waste accumulated in the cavity to be removed from the cavity through the port.

According to still another aspect, a fluid collection management system is provided. The fluid collection management system comprising: a bedpan capable of holding human waste and an outward extending port formed in the bedpan, wherein at least a portion of the human waste contained in the bedpan is capable of passing through the port; a storage element coupled to the bedpan through a conduit and the storage element coupled to an associated suction device for imparting a suction force to the port to remove at least a portion of the associated human contained in the bedpan, thereby substantially reducing exposure of human waste to an associated health care providers.

According to still another aspect, a kit is provided. The kit comprising: a bedpan capable of holding human waste; a storage element packaged with the bedpan.

According to another aspect, the bedpan is operably connected to the storage element by a conduit.

According to another aspect, the storage element has a backflow mechanism.

According to still another aspect, a method of manufacturing a bedpan is provided. The method comprising: forming a base member; forming a seat member; securing the seat member to the base member to form a bedpan.

According to still another aspect, the bedpan includes a port.

According to still another aspect, the method wherein at least one of the step of forming the base member or the step of forming the seat member is formed by injection molding.

According to still another aspect, a storage element comprising: a portable vessel for storing human waste, a lid secured to the portable vessel, wherein the lid includes one or more ports for receiving human waste; a handle mechanism secured to the portable vessel, wherein the handle is capable of securing the portable vessel to an associated bed.

According to still another aspect, the portable vessel has a shape selected from the group of a trapezoid, oval, or a rectangle.

According to another aspect, the storage element includes a holding mechanism for securing an associated bedpan to the portable vessel.

The foregoing and other features of the invention are hereinafter more fully described and particularly pointed out in the claims, the following description and the annexed drawings setting forth in detail illustrative embodiments of the invention, such being indicative, however, of but a few of the various ways in which the principles of the invention may be employed.

### BRIEF DESCRIPTION OF THE DRAWINGS

FIGS. 1 illustrates a perspective view of an exemplary bedpan in accordance with aspects of the present invention.

FIG. 2 illustrates a side view of the bedpan illustrated in FIG. 1.

FIGS. 3 and 4 illustrate a perspective view of another exemplary bedpan in accordance with aspects of the present invention.

FIGS. 5 and 6 illustrate cross-sectional views along lines 5-5 and 6-6, as identified in FIG. 4.

FIG. 7 illustrates a perspective view of another exemplary bedpan in accordance with aspects of the present invention.

FIGS. 8-13 illustrate exemplary ports and port coupling mechanisms in accordance with aspects of the present invention.

FIGS. 14-17 illustrate exemplary filters in accordance with aspects of the present invention.

FIG. 18 illustrates an exemplary system in accordance with aspects of the present invention.

FIG. 19 illustrates an exemplary cap in accordance with aspects of the present invention.

FIG. 20 illustrates an exemplary port retro-fitted to a conventional bedpan in accordance with aspects of the present invention.

FIG. 21 illustrates a base member in accordance with aspects of the present invention.

FIGS. 22A-22D illustrate a seat member in accordance with aspects of the present invention.

FIGS. 23 and 24 illustrate exemplary bedpans manufactured from a base member and a seat member.

FIG. 25 illustrates a kit in accordance with the present invention.

FIG. 26 illustrates an exemplary system in accordance with aspects of the present invention.

FIGS. 27A and 27B illustrate exemplary fluid flow in accordance with aspects of the present invention.

### DETAILED DESCRIPTION OF EMBODIMENTS

The present invention is directed to a bedpan having a port for removing human waste contained in the bedpan and a method for removing human waste, especially fluidic human waste deposited into the bedpan, in order to eliminate or substantially reduce exposure to human waste, which may cause infections, spread diseases and/or generally increase healthcare costs. Another aspect of the present invention relates to a filter (also referred to herein as a separator) for preventing human waste of a predetermined size from entering the port, wherein the filter allows for entry of human waste into the port from a plurality of directions. Another aspect of the present invention relates to a storage element having a narrow profile in at least dimension in order to allow placement near and/or directly to a patient's bed and/or other desired location.

The bedpan generally includes a vessel capable of holding human waste (e.g., urine, feces, diarrhea, vomit, etc.) and a port (e.g., nozzle, barb, extender, recess, tapered recess, void, etc.) configured to allow human waste to be removed from the confines of the vessel through the port. As used herein, the term “bedpan” means a portable shallow vessel used by an individual for urination and defecation. A filter/separator is generally provided for preventing solid human waste of predetermined size from entering the port. The filter/separator is generally configured to allow entry of human waste into the port from a plurality of directions. The port is generally adapted to be releasably coupled to a conduit (e.g. general purpose hose, flexible hose, flexible tubing, etc.), which may be adapted to be operably secured to a storage element (e.g., a vacuum canister, evacuation canister, conventional storage canister, etc.). The storage element may also be operably secured to a suction-type device, vacuum-type device and/or a gravity-type device that may enhance the flow of human waste from the vessel to the storage element through the conduit and the port.

Turning to the Figures, an exemplary bedpan 10 in accordance with aspects of the present invention is illustrated. The bedpan 10 may take any shape and form. Generally, the bedpan 10 is sized to be placed under an associated person in a supine, seated and/or prone position. The bedpan 10 generally has a shape that generally conforms to the anatomical details of the human body. Upon reading the specification and the claims appended thereto, one of ordinary skill in the art will readily appreciate that the present invention is applicable to any type of bedpan (e.g., fracture, supine, sit-on, canister, etc.) that is capable of holding human waste and may be configured and/or otherwise outfitted with a port that enables human waste to be removed from the confines of bedpan through the port.

In one embodiment, the bedpan 10 can be similar in shape and geometric configuration to a conventional bedpan. In another embodiment, the bedpan 10 may have an increased internal holding capacity, which makes the bedpan 10 larger in size and capacity than a conventional bedpan. The dimensions of the bedpan 10 may be increased in the longitudinal and/or transverse directions causing the bedpan to become larger in size and having a larger holding capacity than a conventional bedpan. A bedpan having increased size provides additional comfort, increased stability and a larger target area when the bedpan 10 is used by larger patients.

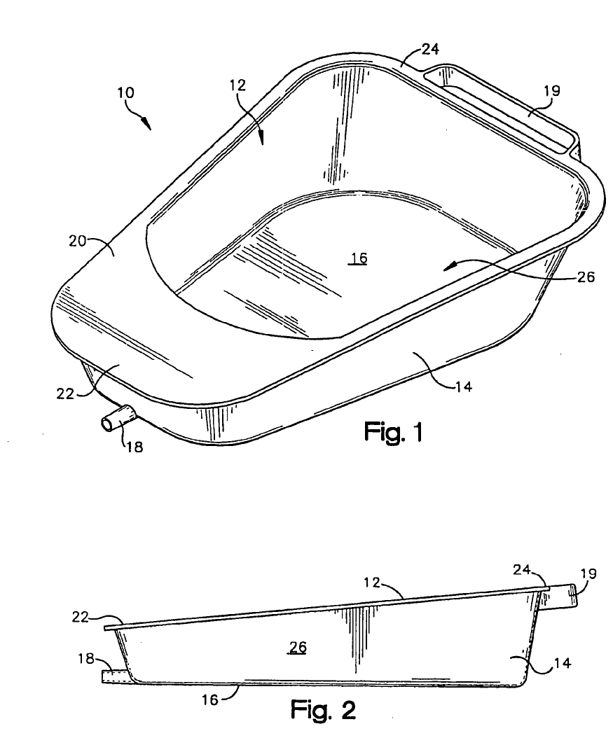

As shown in FIGS. 1-7, the bedpan 10 generally includes a substantially hollow vessel 12 formed from at least one sidewall member 14 and a bottom member 16. The bedpan 10 further includes a port 18 and may optionally include a seat member 20 that may provide support for an associated person to sit, lie or otherwise position themselves thereon.

In one embodiment, the bedpan 10 may also include a cushion (not shown) to provide comfort to the patient positioned on the bedpan 10. Exemplary cushions include padding (e.g., foam, sponge, etc.), gel pads, gel plastic and the like. The cushion may be made from any suitable material and/or manufacturing process (e.g., die cut, injection molded, etc.). Preferably, the cushion is impervious to liquid. In one embodiment, the cushion may be a gel pad having a pressure sensitive adhesive (PSA) for mounting the cushion on top of seat member 20. In addition, the bedpan 10 may also optionally include a handle 19 to facilitate handling of the bedpan 10.

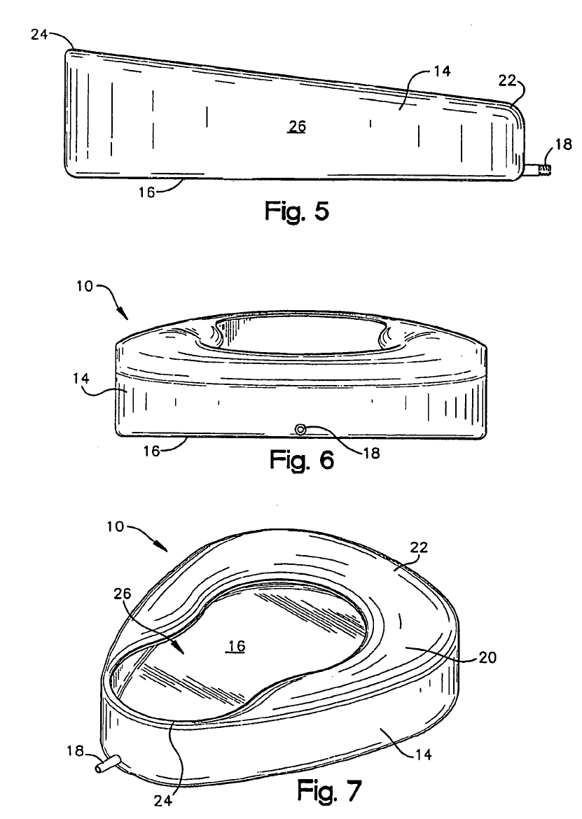

As shown in FIGS. 2 and 5, the bedpan 10 may have a lower profile in the rear portion 22 than the front portion 24, which allows the bedpan 10 to be easily positioned underneath the patient by the healthcare provider, caregiver and/or patient. Alternatively, the bedpan 10 may have a substantially uniform profile, as shown in FIG. 7.

The sidewall member 14 may include one continuous sidewall that may be secured to and/or integrally formed with the bottom member 16. In addition, the sidewall member 14 and/or bottom member 16 may include multiple sections that are connected together and secured to and/or integrally formed with each other. The sidewall member 14 and the bottom member 16 generally form a cavity 26 within the vessel 12. The cavity 26 is capable of holding human waste (e.g., urine, feces, diarrhea, vomit, etc.). The height of the sidewall member 14 may be constant or vary around the circumference or perimeter of the bedpan 10 depending on the environment, medical procedure, patient's physical attributes and/or application in which the device is to be used.

As stated above, the bedpan 10 further includes a port 18. The port 18 may take any form (e.g., a nozzle, a barb, an extender, a recess, a tapered recess, a void, etc.) that allows the human waste contained within the vessel 12 (e.g., in the cavity 26) to be evacuated or otherwise removed from the vessel. The port 18 may be formed integrally with the vessel 12 or may be formed separately from the vessel 12 and secured to the vessel 12. When the port 18 is formed separately and secured to the vessel 12, a portion of the vessel 12 and/or sidewall 14 may be removed in order to establish fluid communication (e.g., allow ingress and/or egress of fluid) between the cavity 26 and the port 18.

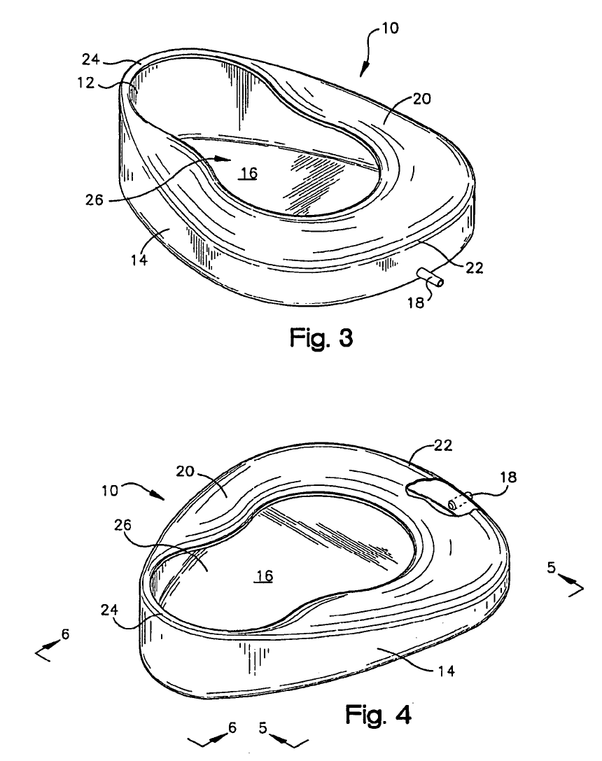

The port 18 may be located on any portion of the bedpan 10. Preferably, the port 18 is located in a position that is easily accessible by a healthcare provider and/or caregiver. For example, the port 18 may be formed and/or secured to the rear portion 22 of the bedpan 10, as shown in FIGS. 1 and 3; formed and/or secured to the front portion 24, as shown in FIG. 7; formed and/or secured to a portion between the rear portion 22 and the front portion 24; formed and/or secured to a top portion of the sidewall, etc. Preferably, one design consideration in determining the location of the port 18 is minimizing stress on the port 18 during use (e.g., during positioning under the patient, during use by the patient, during removal of the waste contents through the port 18, during the cleaning process, etc.).

In order to optimize the amount of human waste that can be eliminated through the port 18, it may be preferable to locate the port 18 at or near the bottom member 16 in order to maximize the effects of gravity and/or applied suction or vacuum forces in order to reduce the amount of physical manipulation (e.g., raising or otherwise angling of the bedpan 10 in order to obtain a greater flow of waste from the vessel 12 and/or cavity 26 through the port 18) required by the healthcare provider and/or caregiver. In one embodiment, the bottom member 16 may be tapered to enhance or other facilitate the flow of human waste through the port 18. Positioning the port 18 in such a manner may eliminate and/or substantially reduce possible exposure to the human waste during the process of moving, emptying and/or cleaning the bedpan 10.

The port 18 may be positioned along any portion of the sidewall member 14. In addition, the port 18 may be positioned along any portion of the bottom member 16. The port 18 may also be positioned along a portion that includes both a portion of the sidewall member 14 and a portion of the bottom member 16. The port 18 may also be positioned along any portion of the seat member 20.

The port 18 generally enables human waste contained in the vessel 12 to be removed through a conduit (e.g. general purpose hose, flexible hose, flexible tubing, etc.) to a storage element (e.g., a vacuum canister, evacuation canister, conventional storage canister, etc.). Preferably, the storage element is operably secured to a device that may enhance the flow of human waste from the vessel 12 to the storage element (e.g., a gravity-type, suction-type, and/or vacuum-type source and/or device).

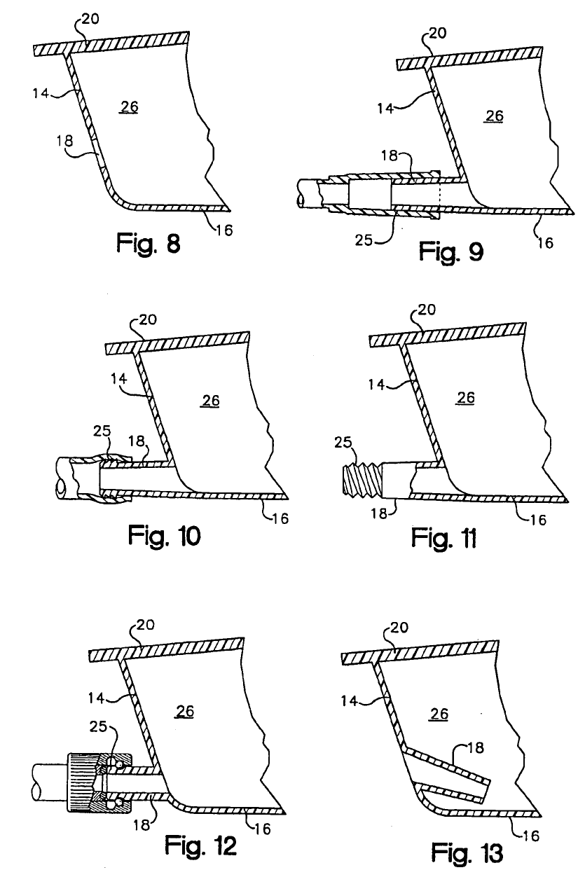

The port 18 can be generally sized to permit all or a portion of the waste contents contained in the vessel 12 (e.g., in the cavity 26) to be evacuated through the port 18. Exemplary forms for the port 18 are illustrated in FIGS. 8-13. For example, the port 18 may be in the form of a void, as shown in FIG. 8. When in the form of a void, the port 18 generally receives a conduit (e.g., general purpose hose, flexible hose, flexible tubing, etc.) that may be secured to the port 18 by any means and/or mechanisms (e.g. friction, threaded, quick connect coupling, etc.).

The port 18 may also include an outward extension, as shown in FIGS. 9-12. The outward extension of the port 18 may be at any desired length and/or angle in relation to the sidewall member 14 and/or bottom member 16. The outward extension may include a coupling mechanism 25, which allows the port 18 to be secured to a conduit that may be operably connected to a storage element (not shown) for storing the waste contents removed from the cavity 26 and/or vessel 12.

When the port 18 extends outwardly from the human waste collection device 10, it is preferable to provide one end (e.g., the free end) of the port 18 with a coupling mechanism 25 that allows the port 18 to be easily and conveniently secured to a conduit (e.g., general purpose hose, flexible hose, tubing, etc.) that may lead to a storage element (e.g., a conventional canister or device, a gravity-type canister or device, a suction-type canister or device and/or a vacuum-type canister or device). Any type of coupling mechanism may be used in accordance with the present invention. Exemplary coupling mechanisms are illustrated in FIGS. 9-12 and include, for example, a press-fit coupling (FIG. 9), a barbed-type friction coupling (FIG. 10), a threaded coupling (FIG. 11) and a quick connect coupling (FIG. 12). One of ordinary skill will readily appreciate that a wide range of coupling mechanisms may be used in accordance with the present invention.

The port 18 may also be recessed within the cavity 26. For example, as shown in FIG. 13, the port 18 may be configured to receive a conduit (e.g., general purpose hose, flexible hose, tubing, etc.), which may be inserted into the cavity 26 of the bedpan 10. Any coupling mechanism 25 may be used to secure the conduit to the port 18. When the port 18 is recessed, as shown in FIG. 13, it is preferable that the conduit is secured to the port 18 by way of friction, which allows the healthcare provider and/or caregiver the ability to easily couple and uncouple the conduit from the port 18. In one embodiment, the recessed port 18 may have a circumference that is reduced (or tapered) from the outside of the vessel 12 (larger circumference) to the inner portion of the vessel (e.g., cavity 26) (smaller circumference) or vice versa.

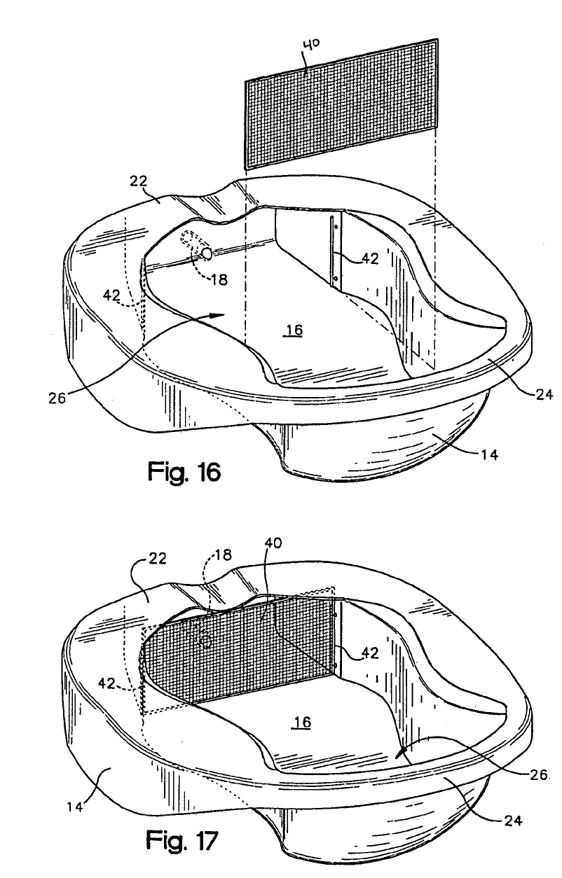

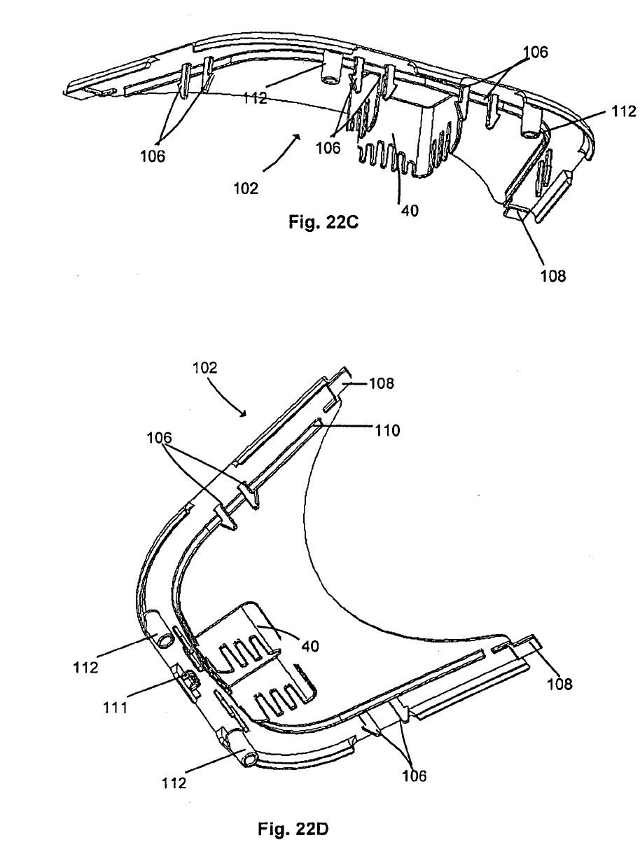

As shown in FIGS. 14-17 and 22, the bedpan 10 may also include a filter/separator 40. The filter/separator 40 may be integral to one or more portions of the bedpan 10, as shown in FIGS. 22A-D. In another embodiment, the filter/separator 40 may be formed of a separate material in the form of, for example, a screen, a mesh, grid, permeable membrane, etc. The filter/separator 40 may take any size or shape and generally prevents particles of human waste from entering the port 18, which could partially and/or totally block the egress of human waste through the port 18. Preferably, the filter 40 prevents particles larger than a predetermined size from entering the port 18.

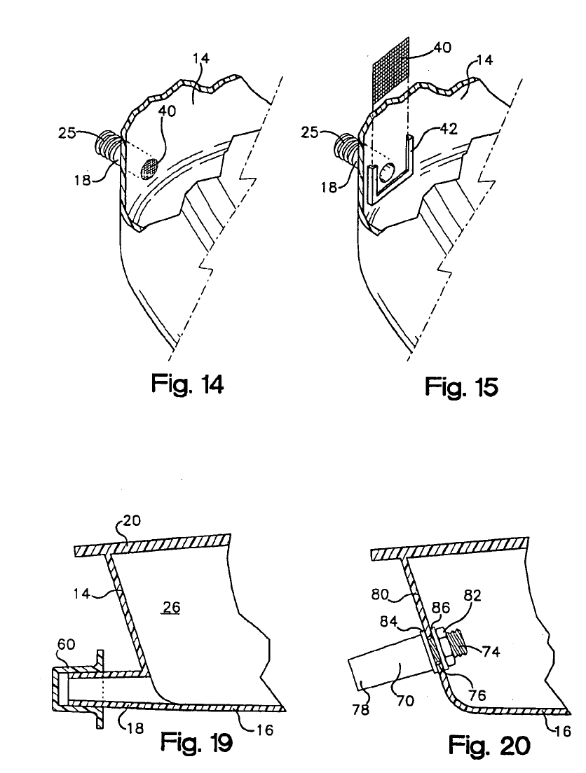

As stated above, the filter 40 may be formed integrally with the bedpan 10 during the manufacturing process, as shown in FIGS. 14 and 22. The filter 40 may also be in the form of an insert in the form of a press-fit and/or slide mounted insert as shown in FIGS. 15-17. When the filter 40 is press-fit and/or slide mounted, a mounting mechanism 42 may be secured to the desired portion of the bedpan 10 (e.g., on the sidewall member 14 and/or bottom member 16 near the port 18). The filter 40 may include any type of arrangement including uniform spacing, non-uniform spacing or a combination of sections of uniform and non-uniform spacing. In addition, as discussed more fully below, the filter/separator 40 may be formed to separate liquid waste from solid waste and allow entry of human waste into the port from a plurality of directions, which may be non-parallel, from multiple planar surfaces, from a curved surface, etc.

An exemplary method of manufacturing the bedpan 10 is illustrated in FIGS. 21-23. The method includes manufacturing two separate members (e.g., base member 100 and seat member 102), which are designed to be combined together to form the bedpan 10. Referring to FIG. 21, the base member 100 is a hollow vessel that generally includes a cavity 12 formed by a sidewall member 14 and bottom member 16. A port 18 may extend through the sidewall member 14, the bottom member 16 and/or through a combination of the sidewall 14 and the bottom member 16. The base member 100 may include one or more slots 104 to secure the seat member 102 to the base member 100. The base member 100 may also include a handle 19, which facilitates movement of the base member 100 and the resulting bedpan 10 when the combined with the seat member 102. The base member 100 may also include protrusion 105 to secure a cap and/or plug to the bedpan 10. The protrusion 105 may be any suitable size and shape.

As shown in FIGS. 22A-22D, projections 106 are placed around the periphery of the seat member 102 for securing the seat member 102 to the base member 100. Additional securing and alignment mechanisms may also be used to secure the seat member 102 to the base member 100. For example, interlocking tabs 108 (e.g., interlocking ship lap, tongue and groove, etc.) may be used to engage against a portion of the base member 100. Also, a locating rib 110 may be used to align the seat member 102 with the base member 100. As shown, the locating rib 110 generally is formed to have substantially the same shape as a portion of the base member 100. The locating rib 110 may also create a seal to ensure liquid and/or other human waste does not leak from the cavity 12.

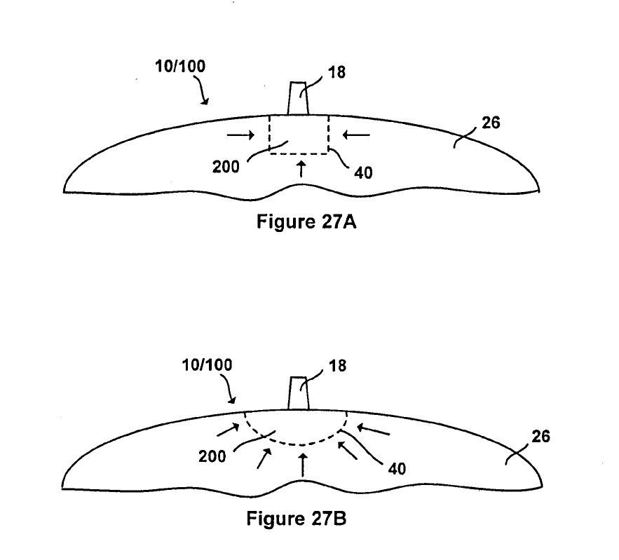

The seat member 102 also may include a filter/separator 40 formed or secured thereon. Alternatively the base member 100 may include the filter/separator 40 secured thereon. As shown in FIGS. 22A-22D the filter/separator 40 may integrally formed in the seat member 102 during manufacturing. The filter/separator 40 is generally molded to prohibit or limit the amount of solid human waste material that is capable of entering the port 18. In one embodiment, the filter/separator functions to separate solid human waste from fluid human waste for evacuation out of the port 18. As shown in FIGS. 27A and 27B, the filter/separator 40 preferably is spaced apart from the port and/or forms a cavity 200 around the entry to the port 18 and allows fluid to enter the port 18 from a plurality of directions (or planes), as shown by arrows indicating the direction of flow from the cavity 26. The cavity 200 may be any desired size. As shown in FIGS. 22A-22D and FIGS. 27A and 27B, fluidic waste may enter the port 18 once the fluidic waste has advanced through the filter/separator 40 of the bedpan 10/100. For example, as shown in FIG. 27A, once the fluid has advanced through one of the three planar surfaces that form the filter/separator 40, the fluid may enter the port 18. Likewise, once the fluid has advanced through the curved filter/separator 40 of FIG. 27B, the fluid may enter the port 18. This is a substantial improvement over prior art devices that are generally positioned at or near the port and allow fluid flow from only one direction. Such prior art devices are easily clogged, which leads to a substantial portion of the fluidic waste remaining in the cavity of the bedpan. The filter/separator 40 provides multiple pathways for the fluidic waste to enter the port 18. This allows substantially all of the fluidic waste contained in the cavity of the bedpan to be eliminated through the port. Since fluidic waste is a known carrier of diseases and other contaminants, it is desirable to eliminate the fluidic waste from the cavity of the bedpan prior to manipulation of the bedpan after use by a patient. This makes the bedpan substantially easier and safer to handle, since the healthcare provider does not have to take special care to prevent spillage of the fluidic waste.

The seat member 102 also may include a locking member 111 that engages with or acts in concert with to provide a mechanism to secure a cap and/or plug to the bedpan 10. As shown in FIGS. 22C and 22D, seat member 102 may also include projections (e.g., bosses) 112. The projections 112 may be any desired size and shape (e.g., circular, square, rectangular, star-shaped, etc.) The projections 112 may be solid or hollow. The projections 112 are preferably sized to be secured to the conduit 52. In one embodiment, the projections 112 having one end of the conduit secured thereto and the other end secured to the port 18 of the bedpan 10 provide a convenient manner for the moving, cleaning or otherwise using a soiled bedpan 10.

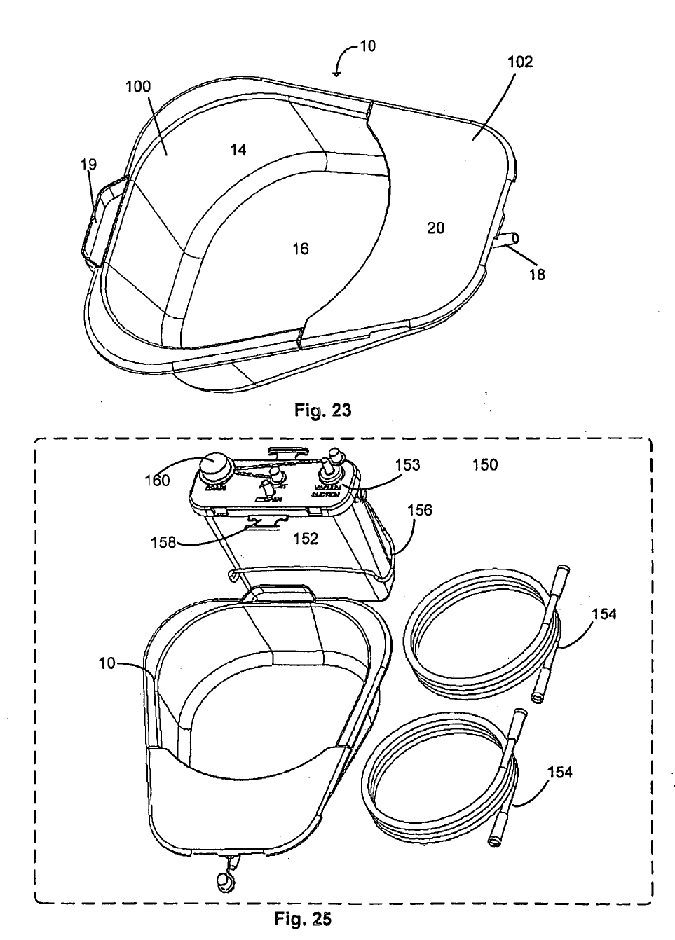

As shown in FIG. 23, when combined, the base member 100 and seat member 102 form the bedpan 10. Preferably, the base member 100 and seat member 102 are injection molded from separate molds. One of ordinary skill in the art will readily appreciate that the bedpan 10 in accordance with the present invention can be manufactured from any suitable material (e.g., plastic, metal, glass, etc.) using any suitable manufacturing process (e.g., blow mold, injection mold, casting, forging, etc.). One of ordinary skill in the art will readily appreciate that although the above description discusses the filter/separator 40 being formed in the seat portion member 102, the filter/separator may also be formed in the base 100 member.

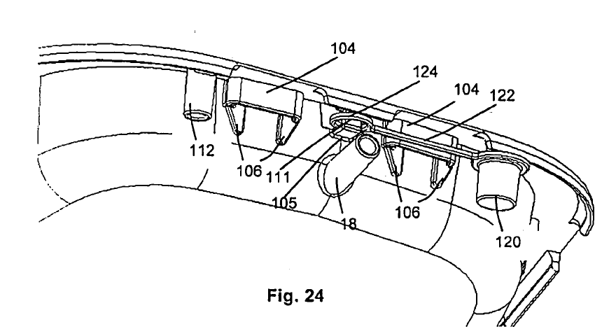

Referring to FIG. 24, the projections 106 of the seat member are engaged or otherwise fastened to the slots 104 of the base member 100, which secures the seat member 102 to the base member 100. As shown in FIG. 24, a cap and/or plug 120 is secured by the locking member 111 of the seat member 102 and the protrusion 105 of the base member 100 to the bedpan 10. The cap and/or plug 120 generally may have a flexible stem 122 with a base portion 124. The base portion 124 is preferably placed on the protrusion 105 before the seat member 102 is secured to the base member 104. Once the seat member 102 is properly aligned and the base portion 124 is positioned in the protrusion 105, the seat member 102 may be firmly pressed to engage projections 106 with slots 104 and locking member 111 with protrusion 105.

The cap and/or plug 120 may be attached to the projections 112 in order to avoid interference from the cap and/or plug 120 during use by the patient. In addition, the cap and/or plug 120 may be secured to the port 18 for a variety of reasons, for example, to facilitate transport, cleaning, repositioning of the bedpan 10 without concern that any human waste contained in the bedpan 10 will escape through the port 18.

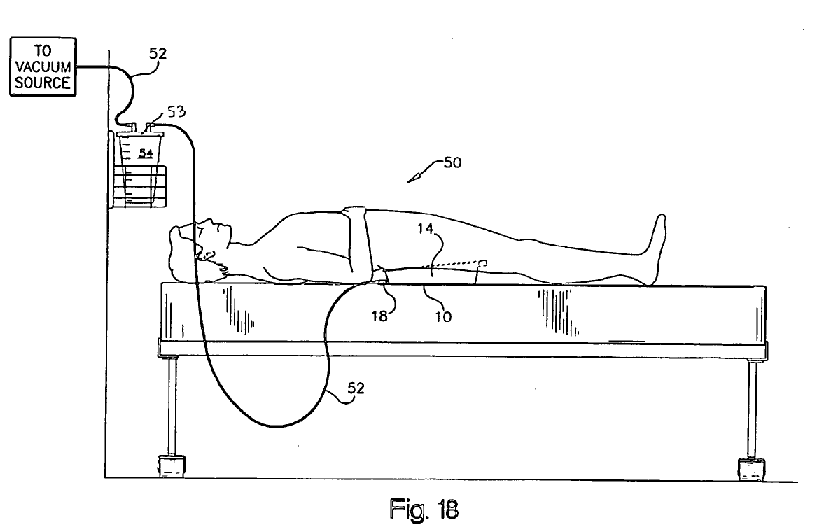

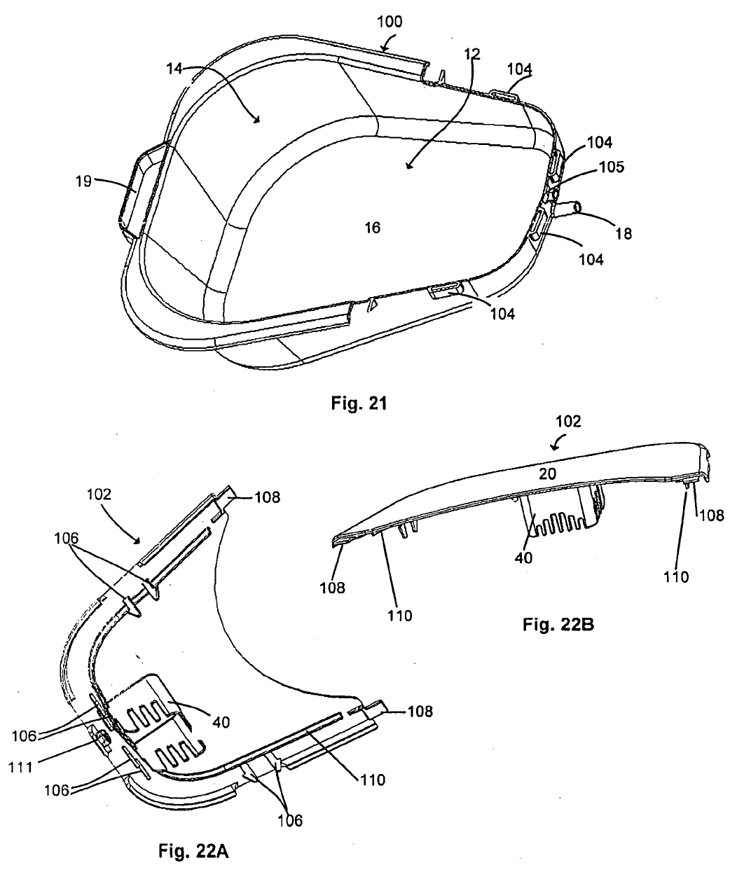

Referring to FIG. 18, an exemplary fluid collection system 50 in accordance with one aspect of the invention is illustrated. The human waste collection system 50 includes a bedpan 10, a conduit 52, and a storage element 54 (e.g., conventional storage canister, vacuum canister, evacuation chamber, custom canister, etc.). As shown in FIG. 18, the bedpan 10 may be placed under (or near) a patient needing to eliminate bodily waste. As shown, the port 18 can be affixed to the sidewall member 14 of the bedpan 10. The conduit 52 (e.g. general purpose hose, flexible hose, flexible tubing, etc.) can be secured to the port 18 and to the storage element 54 by any coupling mechanism 25.

Preferably, the storage element 54 (e.g., vacuum canister, evacuation chamber, etc.) is operably connected through one or more ports on the lid 53 to a suction-type, vacuum-type device and/or gravity-type device (not shown) that may enhance the flow of human waste from the bedpan 10 to the storage element 54. The conduit 52 may be a standard flexible tubing (e.g., a 5 mm diameter, 6 mm diameter, 7 mm diameter, etc.) that may be operably connected to the storage element 54. The storage element 54, in the form of a vacuum canister is widely used in hospitals, operating rooms, doctor's offices, and/or nursing homes.

Generally, the storage element 54 may be operably connected to a suction-type, vacuum-type and/or gravity-type device (not shown). The suction-type, vacuum-type and/or gravity-type device can take a variety of forms including a central vacuum system that is commonly used in hospitals in the United States, wherein the central vacuum source supplies a suction port to a number of hospital and/or operating rooms. Alternatively, a dedicated vacuum source may also be used. One of ordinary skill in the art will readily appreciate that the present invention may utilize any suitable conduit, storage element and/or suction-type, vacuum-type and/or gravity-type device that can safely and securely transfer human waste from the bedpan 10 through the port 18.

In practice, it is preferable that the conduit 52 be attached to the port 18 of the bedpan 10 before or after use by the patient. At the desired time, either before, during the patient's elimination of bodily waste or afterwards, the healthcare provider and/or caregiver may initiate a suction, vacuum and/or gravity force to the storage element 54, which thereby initiates a suction force to the cavity 26 through the port 18 and the conduit 52. Preferably, the suction and/or vacuum force are maintained until substantially all fluidic human waste is removed from the cavity 26 of the bedpan 10. Typically, the human waste will be removed from the cavity 26 through the port 18 and stored in a storage element 54, as shown in FIG. 18. By removing substantially all or a portion of the fluidic human waste while the bedpan 10 is positioned near or under the person using the bedpan 10, the risk of exposure to human and infections and/or diseases caused by exposure to human waste is significantly reduced for the healthcare provider and/or the caregiver, as well as the patient.

The bedpan 10 may also be used while the bedpan 10 is not connected to the storage element 54 and/or conduit 52. In such circumstances, a cap and/or plug 60 may be used to ensure that the contents of the bedpan 10 do not permeate or otherwise escape through the port 18 when in use and/or during transport for disposal and/or cleaning, as shown in FIGS. 19. Preferably, a press-fit connection is used to secure the cap 60 to the port 18. One of ordinary skill in the art will readily appreciate that a variety of mechanical structures may be used to ensure the human waste contained within cavity 26 of the bedpan 10 does not escape through the port 18 when the conduit 52 is not attached thereto.

Another embodiment of the present invention is illustrated in FIG. 25. As shown in FIG. 25, the bedpan 10 may be part of a kit 150. The kit 150 may include a bedpan 10, a storage element 152 for storing human waste and, optionally may include one or more sections of conduit 154 (e.g., tubing) for connecting the bedpan 10 to the storage element 152. The conduit 154 may also be coupled to a vacuum and/or suction source to impart a vacuum and/or suction force to the storage element to facilitate removal of the human waste contained in the bedpan 10. In order to reduce costs associated with storing and shipping the kit 150, it is preferable that the storage element 152 and the one or more sections of conduit 154 fit within the cavity 12 of the bedpan 10.

The bedpan 10 for the kit 150 is any bedpan taking one or more of the forms discussed herein. The storage element 152 may be any type of storage element, including a plastic container (e.g., hard plastic container, plastic bag, etc.), a bag, or any other device that is capable of storing human waste. Preferably, the storage element 152 may be operably connected to a suction-type, vacuum-type and/or gravity-type device as disclosed in connection with storage element 54. The storage element 152 may also include measurement scales that enable a healthcare provide and/or caregiver to measure the human waste expelled into the cavity 26 of the bedpan 10.

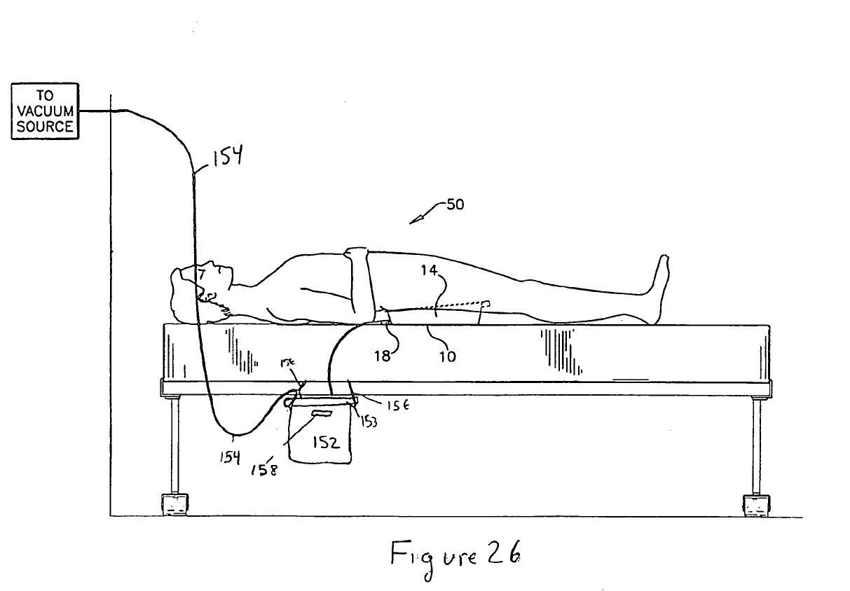

As shown in FIG. 26, the storage element 152 may be secured to a patient's bed (e.g., underneath the patient's bed) by any suitable handle mechanism 156 (e.g., a bale arm, a fastener, mounting bracket, shelf, portable or stationary stand, hook, etc.). It may be desirable to discreetly locate the storage element 152 so as to prevent viewing of the contents stored in the storage element 152 by a casual observer. The storage element 152 may also include one or more clasps 158 (shown in FIG. 25) that may be used to secure the conduit 154 when the conduit is not in use. The clasps 158 may also be used as a holding mechanism, which is operable to hold the bedpan 10 when the bedpan 10 is not use on the storage element 152.

The storage element 152 may be made of any material. Preferably the storage element 152 is made of a polypropylene or polyethylene type material. The storage element 152 may be any size or shape. Preferably the storage element 152 is a rectangular, trapezoidal, or oval shaped container. Due to the relatively thin profile of such shapes, the storage element 152 will not unduly interfere with the activities of health care providers and/or care givers seeking access to the patient on the procedure bed while the storage element 152 is secured to the patient's bed. Due to the narrow profile, it may be beneficial to place additional support along portions of the storage element (e.g. near the opening of the storage element 152) to prevent collapse of the storage element.

In one embodiment, the storage element 152 includes a mechanism 160 (not shown) in the lid 153 of the storage element to prevent backflow (e.g., to prevent human waste from leaving the storage element through the conduit 154). In one embodiment, mechanism 160 is generally a contained sphere that is buoyant when in contact with liquid. In operation, the sphere will rise with the liquid until it reaches the sealing surface of the mechanism 160 preventing human waist from leaving the container, and entering the suction device and/or container. The lid 153 may contain any combination if inlet and/or outlet ports to allow human waste to be drawn into the storage element 152 with or without a vacuum-source and/or suction source.

The storage element 152 may be used in connection with the kit 150 or in conjunction with one or more additional components (not shown) depending on the application in which the storage element 152 may be used. Because of the thin profile of the storage element 152, the storage element 152 may be conveniently used in a wide variety of applications. Such applications include: collection of fluids from oral and nasal cavities, collection of fluids from a patient's airways, endotracheal tube, tracheotomy, wounds, nasogastric tubes, abdominal tubes (e.g., T-Tubes, GI tubes, etc.), rectal pouches, rectal tubes, etc.

An additional advantage of the present invention is the ability to retrofit conventional bedpans to be used in accordance with the present invention. As shown in FIG. 20, the method generally comprises: providing a bedpan having a cavity for holding human waste; forming a hole (or void) into the cavity of the bedpan through a sidewall member and/or bottom member; and securing a port to the bedpan, wherein the port is in fluid communication with the cavity. For example, a conventional bedpan may configured by forming a suitable hole (or void) into the cavity of the conventional bedpan. Preferably, the location of the hole (or void) is near the lower portion of the sidewall member, near the bottom member of the conventional bedpan. Once the hole is formed, the port 70 may be secured to the bedpan 72. Preferably, a threaded portion of the port 74 enters the formed hole (or void) 76, with the free end of the port 78 extending outward from the sidewall member 80, as shown in FIG. 20. A locking mechanism 82 (e.g., a nut) may be used to secure the port 70 to the exterior of the sidewall member 80. Preferably, compliant washers 84, 86 are placed on the interior and exterior of the conventional bedpan, respectively, in order to form a well sealed (liquid impermeable) structure. The free end 78 of the port 70 may also include a fastening mechanism (e.g., threaded portion, friction, quick connect, etc.) that allows the port 70 to be easily and conveniently secured to a gravity-type, suction-type and/or vacuum-type device. A filter/separator may also be secured to cover the port 70. One of ordinary skill in the art will readily appreciate that there are a variety of ways to secure the port structure 70 to a vessel structure, in accordance with the present invention.

Although the invention has been shown and described with respect to a certain preferred embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A bedpan comprising:
a portable vessel including at least one sidewall member and a bottom member, wherein the at least one sidewall member and the bottom member (16) are configured to define a cavity within the vessel capable of holding human waste, wherein the vessel is substantially rigid and adapted to be placed under an associated person;
a port in fluid communication with the vessel, wherein at least a portion of the human waste deposited in the cavity is capable of egress through the port; and
a filter for preventing human waste of a predetermined size from entering the port, wherein the filter allows for entry of human waste into the port from a plurality of directions.

2. The bedpan of claim 1, wherein the port extends outward from at least a portion of the bottom member of the vessel.

3. The bedpan of claim 1, wherein the port extends outward from at least a portion of the sidewall member of the vessel.

4. The bedpan of claim 3, wherein the filter includes a plurality of planar surfaces that separate at least a portion of the human waste deposited in the cavity from entry into the port.

5. The bedpan of claim 3, wherein the filter includes a substantially curved surface that separates at least a portion of the human wasted deposited in the cavity from entry into the port.

6. The bedpan of claim 1, wherein the port is coupled to a storage element through a conduit.

7. The bedpan of claim 6, wherein the port is releasably coupled to the conduit.

8. The bedpan of claim 6, wherein the conduit is a flexible tubing.

9. The bedpan of claim 6, further including a suction-type device coupled to the storage element for imparting a suction force to the storage element to remove at least a portion of the associated human waste from the cavity.

10. The bedpan of claim 9, wherein the storage element is a vacuum canister.

11. The bedpan of claim 1, wherein the port is recessed within a sidewall member of the vessel and at least partially enters the cavity.

12. A fluid collection management system comprising:
a bedpan according to claim 1, and
a storage element coupled to the bedpan through a conduit, and the storage element coupled to an associated suction device for imparting a suction force to the port for removing at least a portion of the associated human contained in the bedpan, thereby substantially reducing exposure of human waste to an associated health care providers and/or an associated patient.

13. A kit comprising:
a bedpan according to claim 1;
a storage element packaged with the bedpan, wherein the storage element is capable of storing human waste.

14. A bedpan comprising:
a base member including a substantially hollow and portable vessel adapted to hold human waste, wherein the vessel is substantially rigid and is configured to be placed under an associated person and a port formed in the vessel, wherein at least a portion of human waste contained in the vessel is capable of passing through the port and
a seat member adapted to be secured to the base member, wherein the seat member includes a filter for preventing human waste of a predetermined size from entering the port.

15. The bedpan of claim 14, wherein the filter includes a plurality of planar surfaces that separate at least a portion of the human waste deposited in the cavity from entry into the port.

16. The bedpan of claim 14, wherein the filter includes a substantially curved surface that separates at least a portion of the human wasted deposited in the cavity from entry into the port.

17. The bedpan of claim 14, wherein the port is coupled to a storage element through a conduit.

18. The bedpan of claim 17, further including a suction-type device coupled to the storage element for imparting a suction force to the storage element to remove at least a portion of the associated human waste from the cavity.

19. A method of manufacturing a bedpan, the method comprising:
forming a base member, wherein the base member includes a substantially hollow and portable vessel adapted to hold human waste, wherein the vessel is substantially rigid and is configured to be placed under an associated person and a port formed in the vessel, wherein at least a portion of human waste contained in the vessel is capable of passing through the port and
forming a seat member adapted to be secured to the base member, wherein the seat member includes a filter for preventing human waste of a predetermined size from entering the port.

20. The method of claim 19, wherein the filter is formed integrally with the seat member and the filter allows fluidic human waste to enter the port from a plurality of non-parallel directions.
